(19) United States
(12) Patent Application Publication
(10) Pub. No.: US 2003/0047266 A1
(43) Pub. Date: Mar. 13, 2003

(54) Bicycle tire structure

(76) Inventor: Ying-Ming Yang, Changhua (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/948,623

(22) Filed: Sep. 10, 2001

(51) Int. Cl. B60C 9/11

(52) U.S. Cl. 152/557; 152/563

(57) ABSTRACT

A tire structure includes a breaker composed of nylon and kevlar, and a tread is attached on an outside of the breaker. The breaker includes two sidewalls which are formed by the nylon and kevlar woven alternatively with each other at an angle.

### FIELD OF THE INVENTION

The present invention relates to a tire structure including a breaker composed of nylon and kevlar, and a tread which is adhered on an outside of the breaker.

### BACKGROUND OF THE INVENTION

A conventional mountain bicycle tire has an reinforced tread that includes a thicker patterns so as to obtain better grasp and track features. The thicker tread is supposed to prevent sharp pebbles from penetrating through the tire. However, the sidewall of the tire is not reinforced because the manufacturers want to maintain proper flexibility. Unfortunately, most of the flat tires are happened because the sidewalls of the tires are penetrated by sharp objects. Some tire manufacturers use strong material to form the sidewalls of the tires, but most of the strong material is stiff and lacks flexibility.

### SUMMARY OF THE INVENTION

In accordance with one aspect of the present invention, there is provided a tire structure which comprises a breaker composed of nylon and kevlar. The breaker includes two sidewalls which are formed by the nylon and the kevlar woven alternatively with each other at an angle. A tread is attached on an outside of the breaker.

The primary object of the present invention is to provide a tire that has a reinforced sidewall so as to prevent from being penetrated by sharp objects.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a breaker and a tread of the tire of the present invention, and

FIG. 2 is a perspective view to show a section of the tire of the present invention.

### DETAILED DESCRIPTION OF THE PREFERRED EMBODIMENT

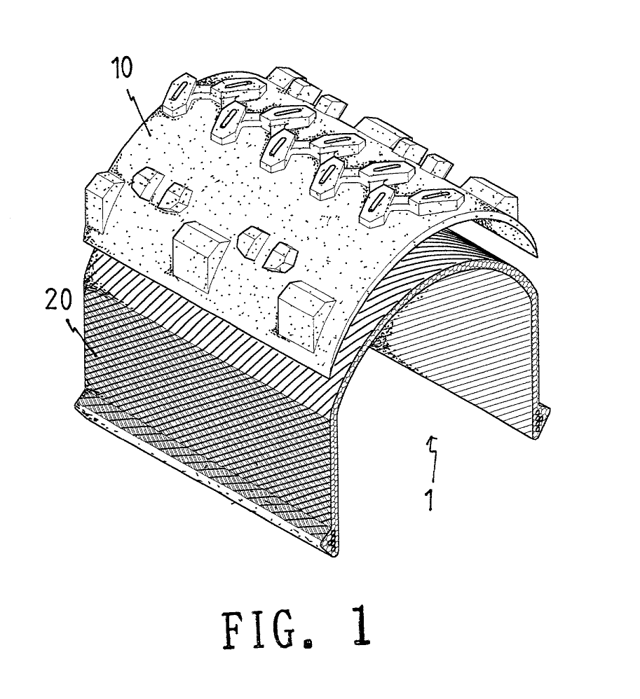

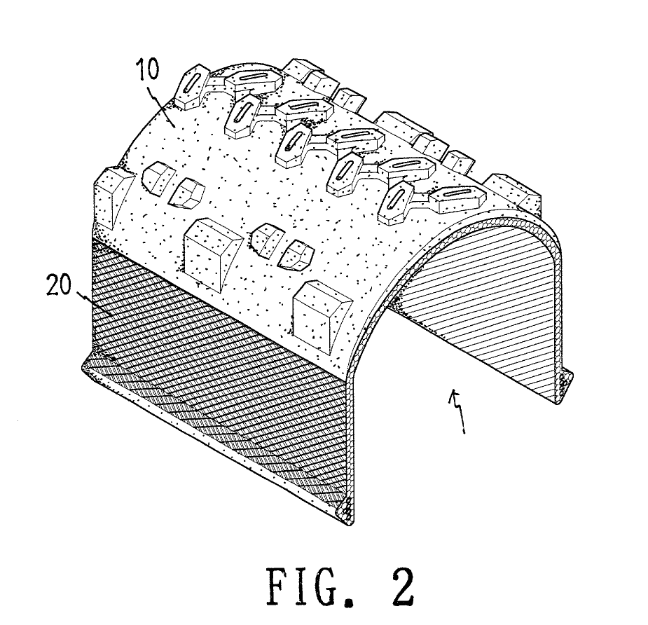

Referring to FIGS. 1 and 2, the tire 1 of the present invention comprises a breaker 20 composed of nylon and kevlar, and a tread 10 is attached on an outside of the breaker 20. The breaker 20 includes two sidewalls which are composed by the nylon and the kevlar, and the nylon and kevlar are woven alternatively with each other at an angle.

The nylon provides good flexibility for the sidewalls and the kevlar prevents from being penetrated or cut by sharp objects. The tire structure is simple and meets the requirements of operation in rough circumstances.

While we have shown and described the embodiment in accordance with the present invention, it should be clear to those skilled in the art that further embodiments may be made without departing from the scope of the present invention.

What is claimed is:

1. A tire structure comprising:
a breaker composed of nylon and kevlar, said breaker including two sidewalls which are composed by said nylon and said kevlar, said nylon and kevlar being woven alternatively at an angle, and
a tread attached on an outside of said breaker.
